(19) United States
(12) Patent Application Publication
(10) Pub. No.: US 2026/0031566 A1
(43) Pub. Date: Jan. 29, 2026

(54) PLUG MOUDLE HAVING AN INTERMEDIARY CONNECTOR

(71) Applicant: TE Connectivity Solutions GmbH, Schaffhausen (CH)

(72) Inventors: Robert Yanos, Middletown, PA (US); John Wesley Hall, Middletown, PA (US)

(21) Appl. No.: 18/974,977

(22) Filed: Dec. 10, 2024

Related U.S. Application Data
(60) Provisional application No. 63/676,583, filed on Jul. 29, 2024.

(51) Int. Cl. H01R 13/514; H01R 13/10; H01R 13/17; H01R 13/627; H01R 24/60; H01R 24/68

(52) U.S. Cl. CPC H01R 13/514; H01R 13/10; H01R 13/17; H01R 13/6273; H01R 24/60; H01R 24/68

(57) ABSTRACT

A plug module includes a plug module housing having shroud walls forming a cavity that is configured to be coupled to a header module. The plug module includes an intermediary connector received in the cavity having an intermediary connector housing with a plug cavity holding intermediary contacts. Each intermediary contact includes mating ends with separable mating interfaces configured to be mated with header contacts of the header module. The plug module includes a plug connector received in the plug cavity having a plug housing holding plug contacts. Each plug contact is coupled to the corresponding intermediary contact. The plug contacts are configured to be electrically connected to the header contacts via the corresponding intermediary contacts.

### CROSS REFERENCE TO RELATED APPLICATIONS

This application claims benefit to U.S. Application No. 63/676,583, filed 29 Jul. 2024, the subject matter of which is herein incorporated by reference in its entirety.

### BACKGROUND OF THE INVENTION

The subject matter herein relates generally to electrical connector systems.

Electrical connector systems are used to electrically connect components of the system. Known electrical systems use header connectors and plug connectors mated with the header connectors to transmit data and/or power between the components. Typically, the plug and header connectors includes latches to latchably couple the plug and header connectors directly to each other. Some systems do not provide adequate space to access such latches to release and unmate the connectors. Additionally, some systems have space constraints requiring the use of specially designed connectors to fit within the space constrains to make the electrical connection. Redesign of the header and plug connectors is expensive.

A need remains for an electrical connector system that may be manufactured in a cost effective and reliable manner.

### BRIEF DESCRIPTION OF THE INVENTION

In one embodiment, a plug module is provided and includes a plug module housing that includes shroud walls forming a cavity. The plug module housing is configured to be coupled to a header module. The plug module includes an intermediary connector received in the cavity and mounted to the shroud walls. The intermediary connector includes an intermediary connector housing that has a plug cavity. The intermediary connector includes intermediary contacts held by the intermediary connector housing. Each intermediary contact includes a first mating end and a second mating end. The first mating end has a separable mating interface configured to be mated with header contacts of the header module. The second mating end is located in the plug cavity. The plug module includes a plug connector received in the plug cavity. The plug connector includes a plug housing holding plug contacts. Each plug contact is coupled to the second mating end of the corresponding intermediary contact. The plug contacts are configured to be electrically connected to the header contacts via the corresponding intermediary contacts.

In another embodiment, an electrical connector system is provided and includes a header module that includes a header module housing having a panel that includes an inner surface and an outer surface. The panel has a window therethrough. The header module includes a header assembly that includes a header circuit board and a header connector coupled to the header circuit board. The header connector includes a header connector housing holding header contacts. Each header contact includes a spring beam that has a separable mating interface. The electrical connector system includes a plug module coupled to the header module. The plug module includes a plug module housing coupled to the panel. The plug module housing includes shroud walls forming a cavity. The plug module includes an intermediary connector received in the cavity and mounted to the shroud walls. The intermediary connector includes an intermediary connector housing that has a plug cavity. The intermediary connector includes intermediary contacts held by the intermediary connector housing. Each intermediary contact includes a first mating end and a second mating end. The first mating end has a separable mating interface configured to be mated with the corresponding header contact. The second mating end is located in the plug cavity. The plug module includes a plug connector received in the plug cavity. The plug connector includes a plug housing holding plug contacts. Each plug contact is coupled to the second mating end of the corresponding intermediary contact. The plug contacts are electrically connected to the header contacts via the corresponding intermediary contacts.

### BRIEF DESCRIPTION OF THE DRAWINGS

FIG. 1 illustrates an electrical connector system in accordance with an exemplary embodiment.

FIG. 2 is a cross-sectional view of the electrical connector system in accordance with an exemplary embodiment.

FIG. 3 is an exploded view of the header connector in accordance with an exemplary embodiment.

FIG. 4 is an exploded view of the intermediary connector in accordance with an exemplary embodiment.

FIG. 5 is an exploded view of the plug connector in accordance with an exemplary embodiment.

FIG. 6 is a perspective views of a portion of the electrical connector system showing the header connector coupled to the intermediary connector and the plug connector in accordance with an exemplary embodiment.

FIG. 7 is another perspective views of a portion of the electrical connector system showing the header connector coupled to the intermediary connector and the plug connector in accordance with an exemplary embodiment.

### DETAILED DESCRIPTION OF THE INVENTION

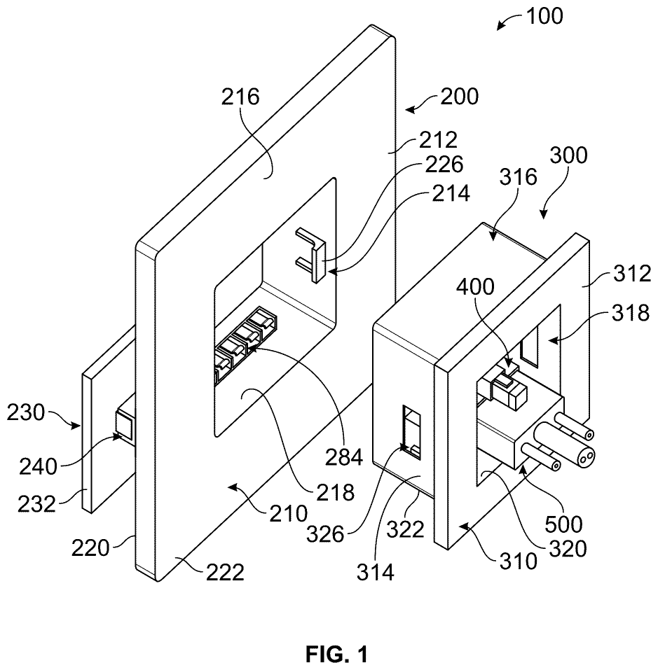

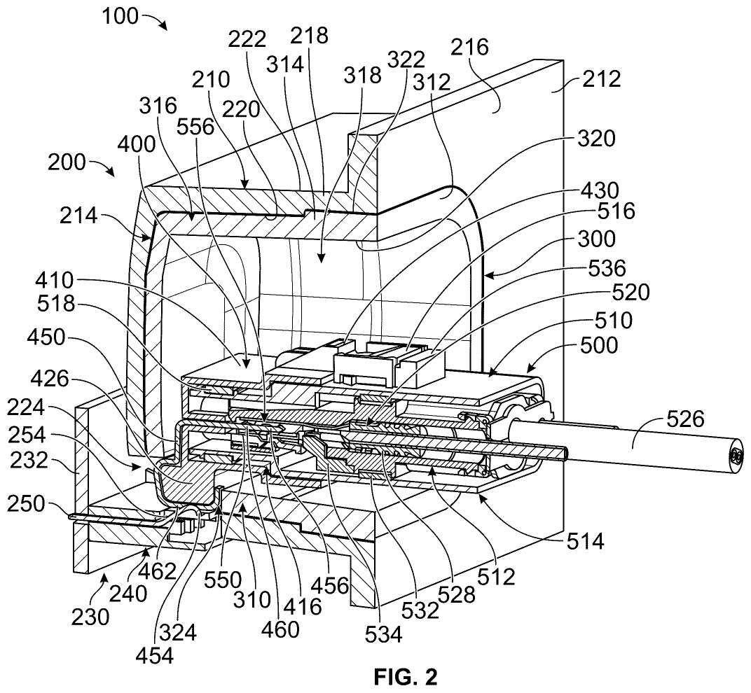

FIG. 1 illustrates an electrical connector system 100 in accordance with an exemplary embodiment. FIG. 2 is a cross-sectional view of the electrical connector system 100 in accordance with an exemplary embodiment. The electrical connector system 100 includes a header module 200 and a plug module 300 configured to be mated with the header module 200. In an exemplary embodiment, the header module 200 and the plug module 300 are mated at a separable mating interface. The separable mating interface allows numerous mating cycles, wherein the plug module 300 is readily mated to and unmated from the header module 200. For example, the header module 200 may be integrated with a fixed component within the system in the plug module 300 is integrated with a movable or removable component within the system.

In an exemplary embodiment, the electrical connector system 100 may be used in an automotive application. For example, the electrical connector system 100 may be used to connect various components or systems within a vehicle. The electrical connector system 100 may be used in various systems within the vehicle, such as the entertainment system, the audio system, a communication system, a charging system, a control system, and the like. In various embodiments, the electrical connector system 100 may be used with components that are separable from each other, such as a removable radio component, removable steering wheel, a removable charging component, a removable Bluetooth device such as a Bluetooth speaker, and the like. The electrical connector system 100 is not limited to automotive applications. The electrical connector system 100 may be used in other applications, such as marine applications, aeronautical applications, computer network applications, industrial applications, or other environments.

The header module 200 includes a header module housing 210 and a header assembly 230 coupled to the header module housing 210. In an exemplary embodiment, the header module housing 210 includes a panel 212 defining a mounting structure within the system. In an exemplary embodiment, the panel 212 includes a pocket 214 configured to receive a portion of the plug module 300. For example, the panel 212 may include a front wall 216 and base walls 218 extending from the front wall 216 forming the pocket 214. The pocket 214 is open at the front to receive the plug module 300. In the illustrated embodiment, the pocket 214 is rectangular. For example, the base walls 218 may include a top wall, a bottom wall, the side walls, and an end wall generally surrounding the pocket 214. The pocket 214 may have other shapes in alternative embodiments, such as circular.

In various embodiments, the panel 212 is metal, such as being a piece of sheet metal. In other various embodiments, the panel 212 is plastic, such as being a molded part. The panel 212 includes an inner surface 220 and an outer surface 222. The plug module 300 may be coupled to the outer surface 222. The header assembly 230 is located behind or inside of the panel 212. For example, the header assembly 230 may be coupled to the inner surface 220 of the panel 212. In an exemplary embodiment, the panel 212 includes a window 224 passing therethrough. The header assembly 230 may be exposed through the window 224. For example, a portion of the header assembly 230 may extend into or through the window 224 to interface with the plug module 300 when the plug module 300 is plugged into the pocket 214. In the illustrated embodiment, the window 224 is located at the bottom of the pocket 214. For example, the window 224 passes through the bottom wall. Other locations are possible in alternative embodiments, such as the end wall, the top wall, and/or one of the side walls.

In an exemplary embodiment, the header module housing 210 includes one or more securing elements 226 used to secure the plug module 300 to the header module 200. In the illustrated embodiment, the securing elements 226 include latches configured to be latchably coupled to the plug module 300. The latches are configured to be released to allow removal of the plug module 300 from the header module 200. Other types of securing elements may be used in alternative embodiments.

The header assembly 230 includes a header circuit board 232 and a header connector 240 coupled to the header circuit board 232. In alternative embodiments, the header connector 240 may be a cable connector terminated to ends of cables rather than being terminated to the header circuit board 232. Electrical components may be coupled to the header circuit board 232 and electrically connected to the header connector 240 through the header circuit board 232. The header circuit board 232 is located behind or interior of the panel 212 of the header module housing 210. Optionally, the header circuit board 232 may be mounted to the panel 212, such as to the inner surface 220 of the panel 212.

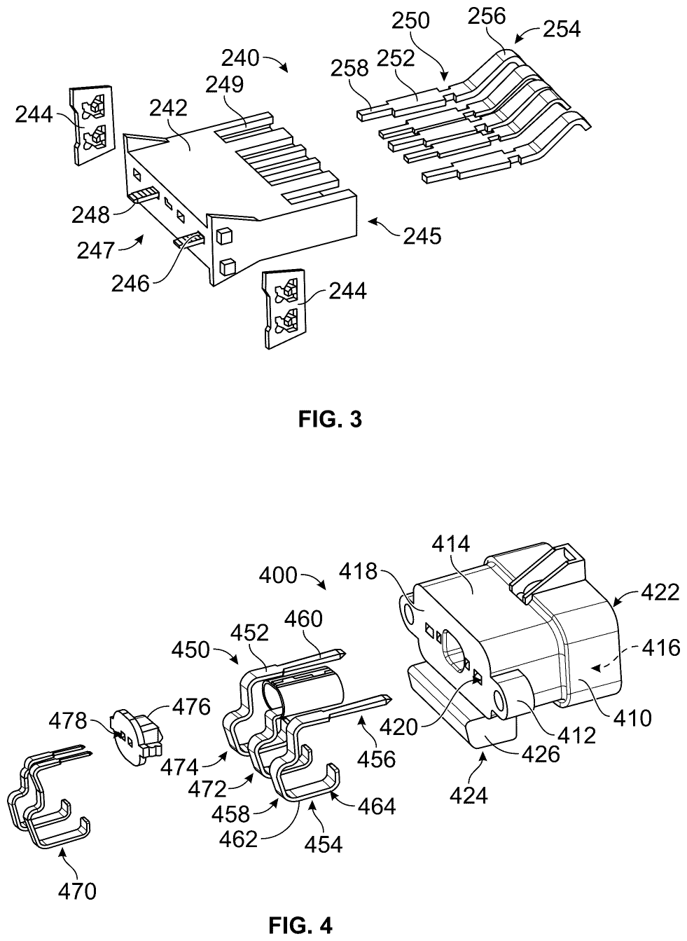

With additional reference to FIG. 3, which is an exploded view of the header connector 240, the header connector 240 includes a header connector housing 242 holding a plurality of header contacts 250. The header connector housing 242 may be mounted to the header circuit board 232. In the illustrated embodiment, solder tabs 244 are used to mount the header connector 240 to the header circuit board 232. The header contacts 250 are electrically connected to the header circuit board 232. For example, the header contacts 250 may be soldered to pads or vias of the header circuit board 232. Alternatively, the header contacts 250 may be press-fit into plated vias of the header circuit board 232. The header contacts 250 may include signal header contacts and/or ground header contacts and/or power header contacts. The signal header contacts may be high speed signal contacts and/or low speed signal contacts.

The header connector housing 242 includes contact channels 246 extending between a mating end 245 and a mounting end 247. In the illustrated embodiment, the mating end 245 is at the front and the mounting end 247 is at the rear. Other orientations are possible in alternative embodiments, such as the top and/or the bottom. In other alternative embodiments, the header connector housing 242 may be a right-angle connector having the mating end 245 perpendicular to the mounting end 247. In an exemplary embodiment, the header connector housing 242 includes mounting posts 248 at the mounting end 247. The mounting posts 248 are used to mount the header connector housing 242 to the header circuit board 232. In an exemplary embodiment, the header connector housing 242 includes openings 249 at the mating end 245. The header contacts 250 may be exposed through the openings 249. For example, ends of the header contacts 250 may extend into or through the openings 249 for mating with the plug module 300. In the illustrated embodiment, the openings 249 are provided along the top of the header connector housing 242. Other locations are possible in alternative embodiments.

In an exemplary embodiment, the header contacts 250 are stamped and formed contacts. The header contacts 250 may be stamped from a lead frame. Each header contact 250 includes a main body 252 and a spring beam 254 extending from the main body 252 at a mating end of the header contact 250. The spring beam 254 is deflectable. The spring beam 254 includes a separable mating interface 256 configured to be mated to the corresponding contact of the plug module 300. The spring beam 254 may be curved at the separable mating interface 256. The spring beam 254 may be formed to extend into or through the corresponding opening 249 in the header connector housing 242. For example, the separable mating interfaces 256 of the spring beams 254 may be located at the top of the header connector housing 242 to interface with the plug module 300. In an exemplary embodiment, the separable mating interfaces 256 of the spring beams 254 form a wiping contact surface configured to wipe across the corresponding contacts of the plug module 300 during mating. Other types of mating interfaces may be provided in alternative embodiments such as pins, sockets, pads, blades, and the like. In an exemplary embodiment, the header contact 250 includes a pin 258 at the terminating end opposite the mating end. The pin 258 is configured to be plugged into the header circuit board 232. The pin 258 may be a compliant pin, such as an eye-of-the-needle pin configured to be received in a plated via of the header circuit board 232. In alternative embodiments, the pin 258 may be a solder pin configured to be received in a plated via of the header circuit board 232. Alternatively, the pin 258 may be bent at a right angle for soldering to a surface of the header circuit board 232.

With reference back to FIGS. 1 and 2, the plug module 300 includes a plug module housing 310, an intermediary connector 400 and a plug connector 500. In an exemplary embodiment, the plug module housing 310 includes walls 312 defining an outer structure for the plug module 300. In an exemplary embodiment, the walls 312 include shroud walls 314 forming a shroud 316 that forms a cavity 318. The walls 312 may include other walls, such as a front wall extending from the shroud 316. The front wall may be coupled to the front wall 216 of the header module housing 210. The shroud 316 is configured to be plugged into the pocket 214. The shroud 316 is configured to receive the intermediary connector 400 and the plug connector 500. The shroud 316 is open at the front to receive the intermediary connector 400 and the plug connector 500. In the illustrated embodiment, the shroud 316 is rectangular. For example, the shroud walls 314 may include a top shroud wall, a bottom shroud wall, side shroud walls, and an end shroud wall generally surrounding the cavity 318. The shroud 316 may have other shapes in alternative embodiments, such as circular.

In various embodiments, the walls 312 are metal, such as being a piece of sheet metal. In other various embodiments, the walls 312 are plastic, such as being a molded part. The walls 312 include inner surfaces 320 and outer surfaces 322. The inner surfaces 320 of the shroud walls 314 face the cavity 318. The outer surfaces 322 face the header module housing 210. For example, the outer surfaces 322 of the shroud walls 314 face the inner surfaces 220 of the base walls 218. The intermediary connector 400 may be coupled to the inner surface(s) 320 of the shroud walls 314. In an exemplary embodiment, the shroud 316 includes a window 324 passing therethrough. A portion of the intermediary connector 400 may be exposed through the window 324. For example, a portion of the intermediary connector 400 may extend into or through the window 324 to interface with the header connector 240 when the plug module 300 is plugged into the pocket 214. In the illustrated embodiment, the window 324 is located at the bottom of the shroud 316. For example, the window 324 passes through the bottom shroud wall. Other locations are possible in alternative embodiments.

In an exemplary embodiment, the plug module housing 310 includes one or more securing elements 326 used to secure the plug module 300 to the header module 200. In the illustrated embodiment, the securing elements 326 include latch pockets that receive the latches of the header module 200. Other types of securing elements may be used in alternative embodiments.

With additional reference to FIG. 4, which is an exploded view of the intermediary connector 400 in accordance with an exemplary embodiment, the intermediary connector 400 includes an intermediary connector housing 410 holding a plurality of intermediary contacts 450. The intermediary connector housing 410 is configured to be mounted to the plug module housing 310. For example, the intermediary connector housing 410 includes mounting tabs 412 configured to be coupled to the plug module housing 310 using fasteners, latches, adhesive or other securing means.

The intermediary connector housing 410 includes housing walls 414 forming a plug cavity 416 at a front of the intermediary connector housing 410. The plug cavity 416 is configured to receive the plug connector 500. The housing walls 414 include an end wall 418, such as at the rear, forming part of the plug cavity 416. The intermediary connector housing 410 includes contact channels 420 that receive the intermediary contacts 450. The contact channels 420 pass through the end wall 418 to the plug cavity 416. The intermediary contacts 450 are configured to pass through the end wall 418 between the interior and exterior of the intermediary connector housing 410. In an exemplary embodiment, the intermediary connector housing 410 extends between a mating end 422 and a mounting end 424. In the illustrated embodiment, the mating end 422 is at the front and the mounting end 424 is at the rear and/or the bottom. Other orientations are possible in alternative embodiments. In an exemplary embodiment, the intermediary connector housing 410 includes a support base 426 at the mounting end 424. The support base 426 is used to support portions of the intermediary contacts 450. In an exemplary embodiment, the support base 426 is configured to be received in the window 324 of the shroud 316 to interface with the header connector 240.

In an exemplary embodiment, the intermediary contacts 450 are stamped and formed contacts. Each intermediary contact 450 includes a main body 452, a first mating end 454, and a second mating end 456 opposite the first mating end 454. The main body 452 is configured to be coupled to the intermediary connector housing 410. For example, the main body 452 is configured to be received in the corresponding contact channel 420 in the end wall 418. The second mating end 456 extends forward of the main body 452 and is configured to be located in the plug cavity 416 to mate with the plug connector 500. The first mating end 454 extends rearward of the main body 452 and is configured to be mated with the corresponding header contact 250. In an exemplary embodiment, the first mating end 454 includes a hook 458 configured hook around the support base 426 of the intermediary connector housing 410. The support base 426 is used to support and locate the first mating end 454 of the intermediary contact 450. The intermediary contact 450 may have other shapes and features in alternative embodiments.

In an exemplary embodiment, the second mating end 456 includes a pin 460 configured to be mated with the corresponding plug contact of the plug connector 500. Other types of contacts may be provided at the second mating end 456 in alternative embodiments, such as a socket, a blade, a pad, a spring beam, and the like.

In an exemplary embodiment, the first mating end 454 includes a mating pad 462 configured to be mated with the corresponding header contact 250. The mating pad 462 defines a separable mating interface 464 configured to be mated with the spring beam 254 of the corresponding header contact 250. In the illustrated embodiment, the mating pad 462 is located at the bottom of the support base 426 and faces downward. Other locations are possible in alternative embodiments depending on the mating orientation between the intermediary connector 400 and the header connector 240. The mating pad 462 may be rigidly held by the support base 426 such that the mating pad 462 does not move relative to the support base 426. For example, the hook 458 may engage the support base 426 to horizontally and/or vertically locate the intermediary contact 450 relative to the support base 426.

In an exemplary embodiment, the separable mating interface 464 of the mating pad 462 forms a wiping contact surface configured to wipe across the corresponding spring beam 254 during mating. The mating pad 462 is configured to deflect the spring beam 254 during mating there with. The deflection of the spring beam 254 allows mating tolerance between the spring beam 254 and the mating pad 462 in a vertical mating direction. In an exemplary embodiment, the mating pad 462 is elongated front to rear to provide a large surface area for mating with the spring beam 254. The elongated mating pad 462 may allow mating tolerance with the spring beam 254 in the front to rear mating direction. The mating pad 462 has a width, which may be oversized relative to the spring beam 254, to provide a large surface area for mating with the spring beam 254. For example, the width of the mating pad 462 may allow mating tolerance with the spring beam 254 in a side-to-side direction.

In an exemplary embodiment, the intermediary connector 400 includes different types of intermediary contacts 450. For example, the intermediary connector 400 may include signal contacts 470, ground contacts 472, and power contacts 474. The signal contacts 470 and/or the ground contacts 472 and/or the power contacts 474 may be sized and shaped differently. For example, the power contacts 474 may be larger than the signal contacts 470 to accommodate power transmission. The cross-sectional area of the power contacts 474 may be selected based on the current rating for the power contacts 474. In the illustrated embodiment, the ground contact 472 is sized and shaped differently for mating with the plug connector 500. For example, the second mating end 456 of the ground contact 472 may include a socket rather than a pin to interface with the plug connector 500.

In an exemplary embodiment, the intermediary connector 400 includes a dielectric insert 476 configured to hold the signal contacts 470. The dielectric insert 476 is configured to be plugged into the end wall 418, such as into an opening in the end wall 418. The dielectric insert 476 may be press fit into the ground contact 472. The dielectric insert 476 includes multiple contact channels 478 that receive the corresponding signal contacts 470. The dielectric insert 476 positions the signal contacts 470 relative to each other for mating with the plug connector 500. The dielectric insert 476 isolates the signal contacts 470 from each other.

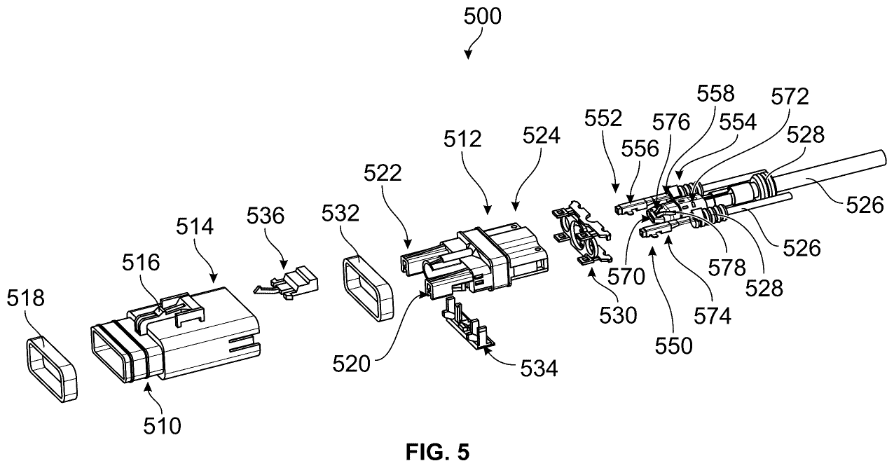

With additional reference to FIG. 5, which is an exploded view of the plug connector 500 in accordance with an exemplary embodiment, the plug connector 500 includes a plug housing 510 holding a plurality of plug contacts 550. The plug housing 510 is configured to be mated to the intermediary connector 400. For example, the plug housing 510 may be plugged into the plug cavity 416 of the intermediary connector housing 410.

In an exemplary embodiment, the plug housing 510 is a multipiece housing. For example, the plug housing 510 includes an inner housing 512 and an outer housing 514. The inner housing 512 is configured to be, at least partially, received in the outer housing 514 the inner housing 512 is configured to receive the plug contacts 550. The outer housing 514 is configured to be mated with the intermediary connector housing 410. For example, the outer housing 514 includes a latch 516 configured to be latchably coupled to the intermediary connector housing 410. In an exemplary embodiment, the plug housing 510 is configured to be sealed. For example, the outer housing 514 holds a plug seal 518 configured to be sealed to the intermediary connector housing 410. In other various embodiments, the plug housing 510 may be a single piece housing rather than a multi-piece housing.

The inner housing 512 of the plug housing 510 includes contact channels 520 that receive the plug contacts 550. The plug contacts 550 may be rear loaded into the inner housing 512. The inner housing 512 may include retention features, such as latches, configured to retain the plug contacts 550 in the contact channels 520.

In an exemplary embodiment, the plug housing 510 extends between a mating end 522 and a cable end 524. In the illustrated embodiment, the mating end 522 is at the front and the cable end 524 is at the rear and/or the bottom. Other orientations are possible in alternative embodiments. Cables 526 are terminated to the corresponding plug contacts 550 and extend form the cable end 524 of the plug housing 510. In an exemplary embodiment, cable seals 528 are coupled to the cables 526 to seal between the cables 526 and the inner housing 512. In an exemplary embodiment, a seal retainer 530 is configured to be coupled to the rear of the inner housing 512 to retain the cable seals 528 in the cable channels 520.

In an exemplary embodiment, the inner housing 512 is configured to be sealed to the outer housing 514. For example, the inner housing 512 and/or the outer housing 514 may hold a housing seal 532. The housing seal 532 is configured to seal against an external surface of the inner housing 512 in configured to seal against an internal surface of the outer housing 514.

In an exemplary embodiment, the plug connector 500 includes a terminal position assurance (TPA) device 534 configured to be coupled to the inner housing 512. The TPA device 534 is used to assure proper positioning of the plug contacts 550 in the contact channels 520. For example, after the plug contacts 550 are loaded into the contact channel 520, the TPA device 534 is coupled to the inner housing 512. If one or more of the plug contacts 550 or improperly loaded into the contact channel 520, the TPA device 534 is unable to be properly installed thus indicating improper assembly. After the plug contacts 550 are properly installed, the TPA device 534 is coupled to the inner housing 512 in the TPA device 534 operates as a secondary lock to retain the plug contacts 550 in the contact channels 520.

In an exemplary embodiment, the plug connector 500 includes a connector position assurance (CPA) device 536 configured to be coupled to the outer housing 514. The CPA device 536 is used to assure proper mating of the plug connector 500 with the intermediary connector 400. For example, the CPA device 536 may be slidably coupled to the outer housing 514. The CPA device 536 is configured to interface with the latch 516 after the latch 516 is latchably coupled to the intermediary connector 400. The CPA device 536 may block unlatching of the latch 516 after the CPA device 536 is actuated.

In an exemplary embodiment, the plug contacts 550 are stamped and formed contacts. Each plug contact 550 includes a mating end 552 and a terminating end 554. The mating end 552 is configured to be mated with the corresponding intermediary contact 450. In the illustrated embodiment, the mating end 552 includes a socket 556. Other types of mating interfaces may be used in alternative embodiments, such as a pin, a spring beam, a blade, a pad, and the like. The terminating end 554 is configured to be terminated to the corresponding cable 526. In the illustrated embodiment, the terminating end 554 includes a crimp barrel 558 configured to be crimped to the end of the cable 526. The crimp barrel 558 may be crimped to the cable seal 528.

In an exemplary embodiment, the plug connector 500 includes different types of plug contacts 550. For example, the plug connector 500 may include signal contacts 570, ground contacts 572, and power contacts 574. The signal contacts 570 and/or the ground contacts 572 and/or the power contacts 574 may be sized and shaped differently. For example, the power contacts 574 may be larger than the signal contacts 570 to accommodate power transmission. In the illustrated embodiment, the ground contact 572 is sized and shaped differently for mating with the intermediary connector 400. For example, the ground contact 572 may surround the signal contacts 570 to form a shield for the signal contacts 570. The ground contact 572 may be terminated to the cable shield of the cable 526. The ground contact 572 includes ground beams 576 configured to interface with the ground contact 472 of the intermediary connector 400. For example, the ground contact 572 may be plugged into the socket of the ground contact 472 such that the ground beams 476 interface with and interior surface of the ground contact 472.

In an exemplary embodiment, one of the cables 526 includes a twisted-pair of signal wires that are terminated to ends of the corresponding signal contacts 570. The signal contacts 570 may be held in a contact holder 578 at the end of the cable 526. The ground contact 572 may surround the contact holder 578 at the mating end thereof.

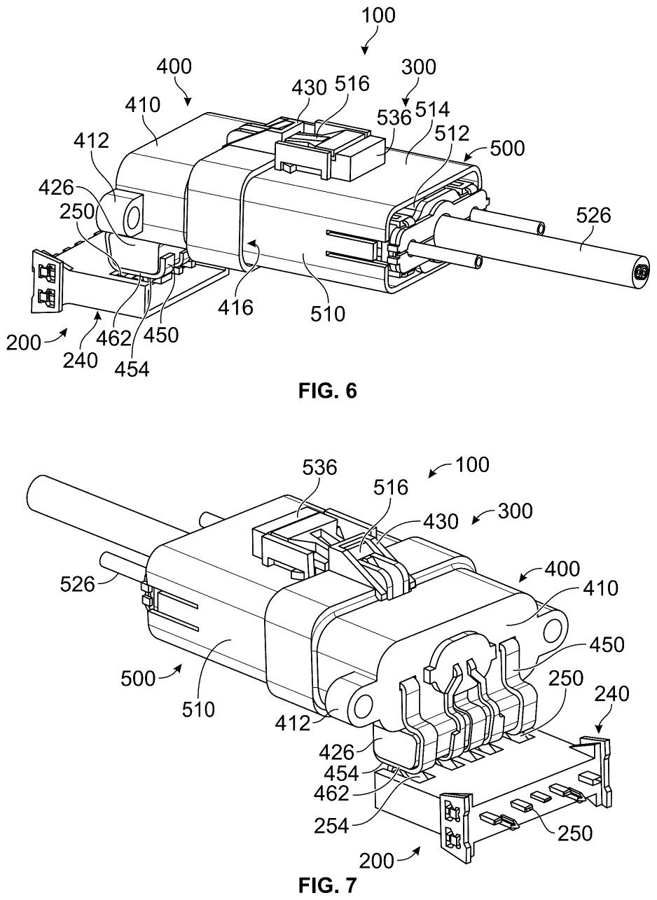

With reference back to FIG. 2 and with additional reference to FIGS. 6 and 7, which are perspective views of a portion of the electrical connector system 100 showing the header connector 240 coupled to the intermediary connector 400 and the plug connector 500, when assembled, the plug contacts 550 are received in the contact channels 520. The cables 526 extend from the plug contacts 550 in the cable seals 528 are sealed in the channels of the inner housing 512. The plug contacts 550 are locked in the contact channels 520. The TPA device 534 is coupled to the inner housing 512 and blocks pull out or removal of the cables 526 in the plug contacts 550 from the inner housing 512. When assembled, the inner housing 512 is located in the interior cavity of the outer housing 514. The inner housing 512 the sealed to the outer housing 514 by the housing seal 532.

The plug connector 500 is coupled to the intermediary connector 400. For example, the plug connector 500 is plugged into the plug cavity 416 of the intermediary connector housing 410. The latch 516 is latchably coupled to a latch element 430 of the intermediary connector 400. The CPA device 536 assures proper mating of the plug connector 500 with the intermediary connector 400 by sliding to an actuated position to block unlatching of the latch 516. The plug housing 510 is sealed to the intermediary connector housing 410 by the plug seal 518. When mated, the plug contacts 550 are coupled to the intermediary contacts 450. For example, the pins 460 at the second mating ends 456 are received in the sockets 556 of the plug contacts 550.

The intermediary contacts 450 extend from the intermediary connector housing 410 to interface with the header contacts 250. The plug contacts 550 are electrically connected to the header contacts 250 by the corresponding intermediary contacts 450. The support base 426 and the first mating ends 454 configured to be received in the window 324 of the shroud 316 to interface with the header contacts 250 of the header connector 240. The first mating ends 454 extend to an exterior of the plug module housing 310 to mate with the header contacts 250. The spring beams 254 of the header contacts 250 form a separable mating interface with the intermediary contacts 450. For example, a wiping contact interface is defined between the spring beams 254 and the mating pads 462 that is configured for use over numerous mating cycles. The mounting tabs 412 of the intermediary connector housing 410 are configured to be mounted to the plug module housing 310 (shown in FIG. 4).

In an exemplary embodiment, the plug module 300 is mated to the header module 200 in a mating direction (for example, right to left in the illustrated view). The mating direction may be a horizontal mating direction. The intermediary contacts 450 are elongated in the mating direction. The spring beams 254 are deflectable in a deflection direction, which may be generally perpendicular to the mating direction. For example, the spring beams 254 may be vertically deflectable during mating with the intermediary contacts 450. The deflection of the spring beams 254 accommodates vertical mating tolerance and/or rotational mating tolerance across the mating interface. The lengths of the mating pads 462 accommodates mating tolerance along the mating direction (for example, front to rear). The mating pads 462 and/or the spring beams 254 may be wide enough to accommodate lateral mating tolerance in a direction perpendicular to the mating direction.

In an exemplary embodiment, the intermediary connector 400 includes a first mating interface defined by the first mating ends 454 for mating with the header connector 240 and a second mating interface defined by the second mating ends 456 for mating with the plug connector 500. In the illustrated embodiment, the first mating interface is axially offset from the second mating interface. For example, the first mating interface is vertically offset from the second mating interface. Optionally, the first mating interface may be horizontally offset from the first mating interface (for example, in the mating direction), such as rearward of the second mating interface. The first mating interface is configured to mate with the header contacts 250 along a first mating axis. The plug connector 500 may be mated to the intermediary connector 400 along a second mating axis. The second mating axis may be generally parallel to and axially offset from the first mating axis.

The intermediary connector 400 defines an adapter between the header connector 240 and the plug connector 500. The intermediary contacts 450 may be routed such that the header connector 240 and the plug connector 500 do not need to be axially aligned. For example, the mating interfaces may be offset vertically and/or horizontally. The intermediary connector 400 may change the types of mating interfaces, such as between a spring beam and pad interface with the header connector 240 and a pin and socket interface with the plug connector 500. The intermediary contacts 450 and the spring beams 254 of the header contacts 250 allow for vertical and/or horizontal and/or rotational float or tolerance at the mating interface. During mating and unmating of the plug module 300 and the header module 200, there is no need to disconnect a connector latch between the header connector 240 and/or the plug connector 500. Rather, the plug connector remains plugged into and latched to the intermediary connector 400 and there is no latch between the intermediary connector 400 and the header connector 240. Rather, the intermediary connector 400 and the plug connector 500 may be removable from the header module 200 as a unit with the plug module housing 310. The spring beams 254 have a separable mating interface that has the potential for high mate cycles.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A plug module comprising:
a plug module housing including shroud walls forming a cavity, the plug module housing configured to be coupled to a header module;
an intermediary connector received in the cavity and mounted to the shroud walls, the intermediary connector including an intermediary connector housing having a plug cavity, the intermediary connector including intermediary contacts held by the intermediary connector housing, each intermediary contact including a first mating end and a second mating end, the first mating end having a separable mating interface configured to be mated with header contacts of the header module, the second mating end located in the plug cavity; and
a plug connector received in the plug cavity, the plug connector including a plug housing holding plug contacts, each plug contact being coupled to the second mating end of the corresponding intermediary contact;
wherein the plug contacts are configured to be electrically connected to the header contacts via the corresponding intermediary contacts.

2. The plug module of claim 1, wherein the intermediary connector includes a first mating interface and a second mating interface, the first mating ends of the intermediary contacts located at the first mating interface, the second mating ends of the intermediary contacts located at the second mating interface, the first mating interface being axially offset from the second mating interface.

3. The plug module of claim 2, wherein the first mating interfaces are configured to mate with the header contacts along a first mating axis, the plug connector be mated to the intermediary connector along a second mating axis, the second mating axis being generally parallel to and axially offset from the first mating axis.

4. The plug module of claim 1, wherein the first mating end includes a mating pad defining a wiping mating interface.

5. The plug module of claim 1, wherein the first mating end is at a bottom of the intermediary connector housing.

6. The plug module of claim 1, wherein the plug module housing includes an opening, the intermediary contacts passing through the opening to an exterior of the plug module housing to mate with the header contacts.

7. The plug module of claim 1, wherein the intermediary connector housing includes a mounting bracket mounted to at least one of the shroud walls.

8. The plug module of claim 1, wherein the plug connector includes a seal sealed to the intermediary connector.

9. The plug module of claim 1, wherein the second mating end includes pins, the plug contacts including sockets receiving the pins.

10. The plug module of claim 1, wherein the intermediary connector includes signal contacts and power contacts, the plug contacts including signal contacts and power contacts.

11. The plug module of claim 1, wherein the plug connector includes a latch configured to be latchably coupled to the intermediary connector.

12. An electrical connector system comprising:
a header module including a header module housing having a panel including an inner surface and an outer surface, the panel having a window therethrough, the header module including a header assembly including a header circuit board and a header connector coupled to the header circuit board, the header connector including a header connector housing holding header contacts, each header contact including a spring beam having a separable mating interface; and
a plug module coupled to the header module, the plug module including a plug module housing coupled to the panel, the plug module housing including shroud walls forming a cavity, the plug module including an intermediary connector received in the cavity and mounted to the shroud walls, the intermediary connector including an intermediary connector housing having a plug cavity, the intermediary connector including intermediary contacts held by the intermediary connector housing, each intermediary contact including a first mating end and a second mating end, the first mating end having a separable mating interface configured to be mated with the corresponding header contact, the second mating end located in the plug cavity, the plug module including a plug connector received in the plug cavity, the plug connector including a plug housing holding plug contacts, each plug contact being coupled to the second mating end of the corresponding intermediary contact;
wherein the plug contacts are electrically connected to the header contacts via the corresponding intermediary contacts.

13. The electrical connector system of claim 12, wherein the intermediary contacts are elongated in a mating direction, the spring beams being deflectable in a deflection direction perpendicular to the mating direction.

14. The electrical connector system of claim 13, wherein the intermediary connector and the plug connector are removable from the header module with the plug module housing.

15. The electrical connector system of claim 13, wherein the header module housing includes a pocket, the spring beams extending into the pocket, the pocket receiving the plug module to interface with the spring beams of the header contacts.

16. The electrical connector system of claim 13, wherein the intermediary connector includes a first mating interface and a second mating interface, the first mating ends of the intermediary contacts located at the first mating interface, the second mating ends of the intermediary contacts located at the second mating interface, the first mating interface being axially offset from the second mating interface.

17. The electrical connector system of claim 16, wherein the first mating interfaces are configured to mate with the header contacts along a first mating axis, the plug connector be mated to the intermediary connector along a second mating axis, the second mating axis being generally parallel to and axially offset from the first mating axis.

18. The electrical connector system of claim 13, wherein the first mating end includes a mating pad defining a wiping mating interface.

19. The electrical connector system of claim 13, wherein the plug module housing includes an opening, the intermediary contacts passing through the opening to an exterior of the plug module housing to mate with the header contacts.

20. The electrical connector system of claim 13, wherein the intermediary connector includes signal contacts and power contacts, the plug contacts including signal contacts and power contacts.
